(19) United States
(12) Patent Application Publication
(10) Pub. No.: US 2026/0042562 A1
(43) Pub. Date: Feb. 12, 2026

(54) NAIL PLATE STACK DE-BANDER SYSTEM AND METHOD OF DE-BANDING A NAIL PLATE STACK

(71) Applicant: Buildz, LLC, Forest City, NC (US)

(72) Inventors: Mark Joseph BELLISSIMO, Wellington, FL (US); Harrison Grant Meadows, Hendersonville, NC (US)

(21) Appl. No.: 19/291,206

(22) Filed: Aug. 5, 2025

Related U.S. Application Data
(60) Provisional application No. 63/679,955, filed on Aug. 6, 2024.

(51) Int. Cl. B65B 69/00; F16B 15/00

(52) U.S. Cl. CPC B65B 69/0025; F16B 15/0023

(57) ABSTRACT

A nail plate stack de-bander system for de-banding a nail plate stack including a plurality of nail plates coupled together by a band. The nail plate stack de-bander system includes a stack press assembly and a stack de-bander assembly. The stack press assembly includes a stack press. The stack press assembly is configured to receive the nail plate stack. The stack press is configured to compress the nail plate stack such that the band expands outwards from the nail plate stack. The stack de-bander assembly includes a stack band spear assembly. The stack de-bander assembly is configured to move the stack band spear assembly to cut the band from the nail plate stack to de-band the nail plate stack.

This application claims priority to U.S. Provisional Ser. No. 63/679,955 filed Aug. 6, 2024, the entire content of which is incorporated herein by reference.

### TECHNICAL FIELD

The present disclosure relates generally to construction of modular construction units. In particular, the present disclosure relates to a nail plate stack de-bander system and a method of de-banding a nail plate stack.

### BACKGROUND

The production of modular, or prefabricated, buildings is a growing industry. In this type of manufacturing, sections of a building or structure, also referred to as a modular construction unit, are partially assembled at a remote location, and the sections are then delivered to the final building site, where final construction of the structure is ultimately completed by assembling the various sections together. Such modular construction units can be used for a variety of purposes, including, for example, as temporary or permanent buildings, such as residential homes, commercial offices, educational or service facilities, etc. Nail plates may be used to secure together components of the modular construction unit.

### SUMMARY

In one aspect, a nail plate stack de-bander system for de-banding a nail plate stack is disclosed. The nail plate includes a plurality of nail plates coupled together by a band. The nail plate stack de-bander system includes a stack press assembly and a stack de-bander assembly. The stack press assembly includes a stack press. The stack press assembly is configured to receive the nail plate stack. The stack press is configured to compress the nail plate stack such that the band expands outwards from the nail plate stack. The stack de-bander assembly includes a stack band spear assembly. The stack de-bander assembly is configured to move the stack band spear assembly to cut the band from the nail plate stack to de-band the nail plate stack.

In another aspect, a method of de-banding a nail plate stack including a plurality of nail plates coupled together by a band is disclosed. The method includes receiving, at the nail plate stack de-bander system, the nail plate stack, compressing, with the stack press, the nail plate stack such that the band expands outward from the nail plate stack, and cutting, with the stack band spear assembly, the band from the nail plate stack to de-band the nail plate stack.

### BRIEF DESCRIPTION OF THE DRAWINGS

The foregoing and other features and advantages will be apparent from the following, more particular, description of various exemplary embodiments, as illustrated in the accompanying drawings, wherein like reference numbers generally indicate identical, functionally similar, and/or structurally similar elements.

FIG. 1 is a top plan view of a system for constructing geometric truss elements for use in assembly of a modular construction unit, according to the present disclosure.

FIG. 2A is a front perspective view of a nail plate stack de-bander system, according to the present disclosure.

FIG. 2B is an enlarged partial view of the nail plate stack de-bander system, taken at detail 2B in FIG. 2A, according to the present disclosure.

FIG. 2C is an enlarged partial rear perspective view of the nail plate stack de-bander system, according to the present disclosure.

FIG. 2D is an enlarged partial top view of the nail plate stack de-bander system, according to the present disclosure.

FIG. 2E is an enlarged view of a stack band spear assembly of the nail plate stack de-bander system, according to the present disclosure.

FIG. 3A is a partial front perspective view of the nail plate stack de-bander system and illustrates a first step of a method of de-banding a nail plate stack with the nail plate stack de-bander system, according to the present disclosure.

FIG. 3B is an enlarged rear perspective view of the nail plate stack de-bander system and illustrates a second step of the method of de-banding the nail plate stack with the nail plate stack de-bander system, according to the present disclosure.

FIG. 3C is an enlarged side view of the nail plate stack de-bander system, taken at detail 3C in FIG. 3B, and illustrates the second step of the method of de-banding the nail plate stack with the nail plate stack de-bander system, according to the present disclosure.

FIG. 3D is a partial front perspective view of the nail plate stack de-bander system and illustrates a third step of the method of de-banding the nail plate stack with the nail plate stack de-bander system, according to the present disclosure.

FIG. 3E is an enlarged top view of the nail plate stack de-bander system and illustrates a fourth step of the method of de-banding the nail plate stack with the nail plate stack de-bander system, according to the present disclosure.

FIG. 3F is an enlarged top view of the nail plate stack de-bander system and illustrates the fourth step of the method of de-banding the nail plate stack with the nail plate stack de-bander system, according to the present disclosure.

FIG. 3G is an enlarged view of the stack band spear assembly and illustrates a fifth step of the method of de-banding the nail plate stack with the nail plate stack de-bander system, according to the present disclosure.

FIG. 3H is an enlarged side view of the stack band spear assembly and illustrates the fifth step of the method of de-banding the nail plate stack with the nail plate stack de-bander system, according to the present disclosure.

FIG. 3I is a partial front perspective view of the nail plate stack de-bander system and illustrates a sixth step of the method of de-banding the nail plate stack with the nail plate stack de-bander system, according to the present disclosure.

FIG. 4 is a flow diagram of a method de-banding a nail plate stack, according to the present disclosure.

FIG. 5 illustrates a computing device for controlling aspects of the nail plate stack de-bander system, according to the present disclosure.

### DETAILED DESCRIPTION

Various embodiments are discussed in detail below. While specific embodiments are discussed, this is done for illustration purposes only. A person skilled in the relevant art will recognize that other components and configurations may be used without departing from the spirit and scope of the present disclosure.

As used herein, the terms “first,” “second,”, “third,” etc., may be used interchangeably to distinguish one component from another and are not intended to signify location or importance of the individual components.

The terms “coupled,” “fixed,” “attached,” “connected,” and the like, refer to both direct coupling, fixing, attaching, or connecting as well as indirect coupling, fixing, attaching, or connecting through one or more intermediate components or features, unless otherwise specified herein.

The singular forms “a,” “an,” and “the” include plural references unless the context clearly dictates otherwise.

As used herein, “de-band” or “de-banding” means cutting a band from a nail plate stack to remove the band from the nail plate stack.

As mentioned above, nail plates may be used in constructing components for a building or a structure. For example, nail plates may be used to construct trusses for use in framing assemblies for the building or the structure. Nail plates are typically provided in a stack of a plurality of nail plates that is typically held together by a band (e.g., a rubber band or the like). Currently, the band is manually removed by a human prior to the nail plates being removed from the stack to be nailed into lumber for constructing the trusses.

Accordingly, the present disclosure provides for a nail plate stack de-bander system that de-bands the nail plate stack. The nail plate stack de-bander includes a stack press carriage having a stack press that is actuated by a stack press cylinder to compress the nail plate stack. Compressing the nail plate stack causes the band to open or otherwise expand away from the nail plate stack. The nail plate stack de-bander system includes a stack band spear that is actuated by a stack band spear cylinder. The stack band spear includes a stack band spear and a stack band cutter. The stack band spear is a wedge, or the like, for sliding between the expanded band and the nail plate stack for holding the band. The stack band cutter cuts the band to de-band the nail plate stack. The stack band cutter includes a plurality of stack band cutter teeth that engage the stack band spear to grab the band. The stack band cutter also includes a knife that then cuts the band.

In operation, the nail plate stack can be robotically loaded into the stack press carriage. A plate of the stack band spear is used as a hard surface to locate the nail plate stack as the nail plate stack is loaded into the stack press carriage. This ensures that the location is consistent for reliable de-banding of a plurality of nail plate stacks. The stack press is then lowered onto the nail plate stack. This causes the band to expand outwards at a center of the band. The stack band spear then retracts away from the nail plate stack in preparation to spear the band. The stack band spear then extends towards the nail plate stack and slides underneath the band which stops against the band locating feature on the stack band spear. When the stack band spear has engaged the band, the stack band cutter closes towards the nail plate stack. As the stack band cutter closes, the teeth grab the band, while the knife simultaneously cuts the band. When the band is cut, the stack press carriage extends distally, stripping the band away from the stack. The stack press opens and the nail plate stack is free to use without the band. The stack band spear retracts, and the cutter opens, which discards the band into a receptable located underneath the nail plate stack de-bander system. The stack press carriage then retracts and is positioned to receive a new nail plate stack to de-band the new nail plate stack. Accordingly, the nail plate stack de-bander system ensures the band is cut and removed from the nail plate stack such that the nail plates can then be used and nailed into lumber for constructing trusses, or the like.

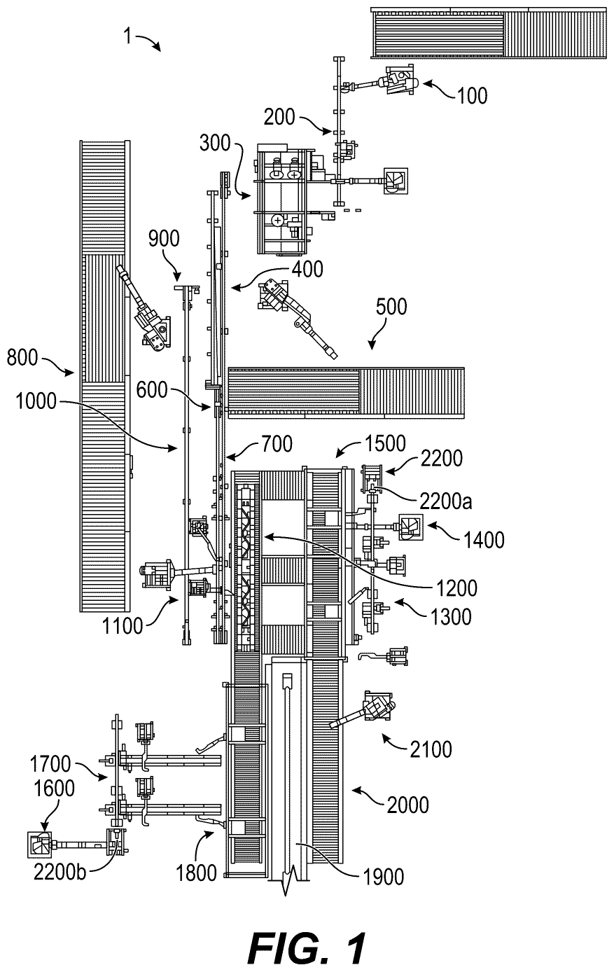

FIG. 1 is a top plan view of a system 1 for constructing geometric truss elements for use in assembly of a modular construction unit, according to the present disclosure. By way of example, the system may include components of the system described in U.S. Patent Application Publication No. U.S. 2024/0051178, the contents of which are hereby incorporated by reference in their entirety. For example, the system 1 can be used for constructing geometric truss elements in an automated manner (e.g., without any manual intervention by a human) for use in assembly of a modular construction unit (e.g., a floor structure or a ceiling structure thereof). As shown in FIG. 1, the system 1 comprises an angled web loading station 100, an angled web rough cut station 200, an angled web finish cut station 300, an angled web delivery station 400, an upright web loading station 500, an upright web cut station 600, an upright web delivery station 700, a truss chord loading station 800, a truss chord cut station 900, a truss chord delivery station 1000, a finished lumber merge/transfer station 1100, a finished lumber jig placement station 1200, a bottom nail plate (BNP) loading station 1300, a BNP delivery station 1400, a BNP jig placement station 1500, top nail plate (TNP) loading station 1600, a TNP delivery station 1700, a TNP jig placement station 1800, a nail plate press station 1900, a finished truss unloading station 2000, and a finished truss storage station 2100.

Many of the stations referred to herein can logically be thought of as belonging to one or more groupings of such sections, which can be operated independently of one or more other groupings. The angled web loading station 100, the angled web rough cut station 200, the angled web finish cut station 300, and the angled web delivery station 400 collectively define what is referred to as the angled web production grouping. The upright web loading station 500, the upright web cut station 600, and the upright web delivery station 700 collectively define what is referred to as the upright web production grouping. The truss chord loading station 800, the truss chord cut station 900, and the truss chord delivery station 1000 collectively define what is referred to as the truss chord production grouping. The BNP loading station 1300 and the BNP delivery station 1400 collectively define what is referred to as the BNP grouping. The TNP loading station 1600 and the TNP delivery station 1700 collectively define what is referred to as the TNP grouping. The BNP jig placement station 1500, the finished lumber jig placement station 1200, the TNP jig placement station 1800, the nail plate press station 1900, and the finished truss unloading station 2000 collectively define the truss element assembly grouping.

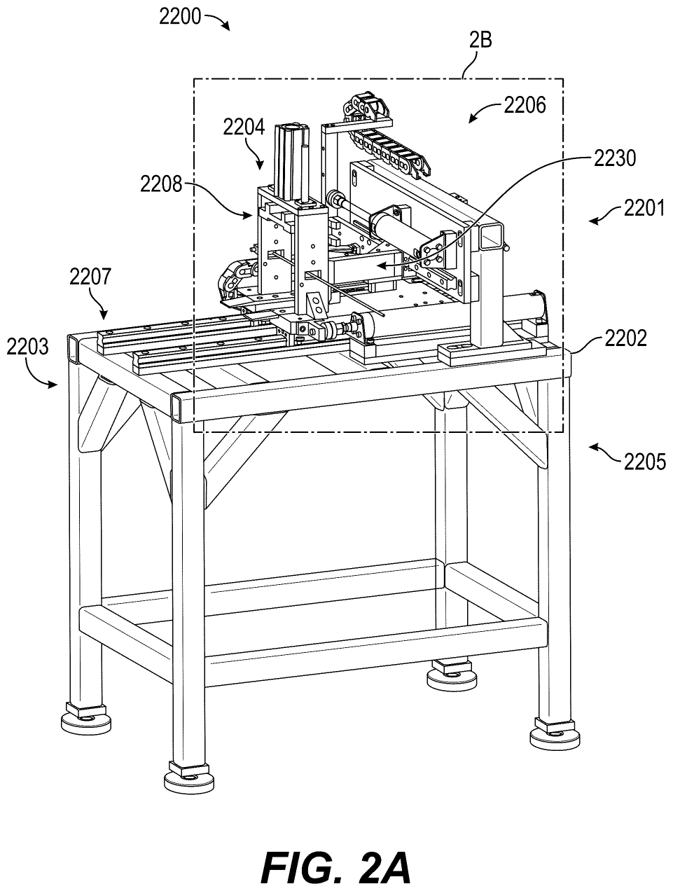

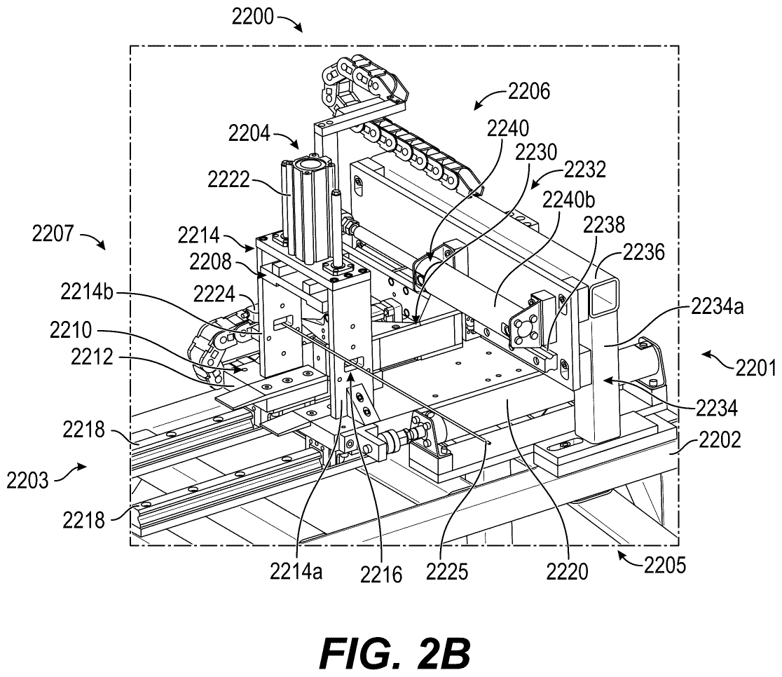

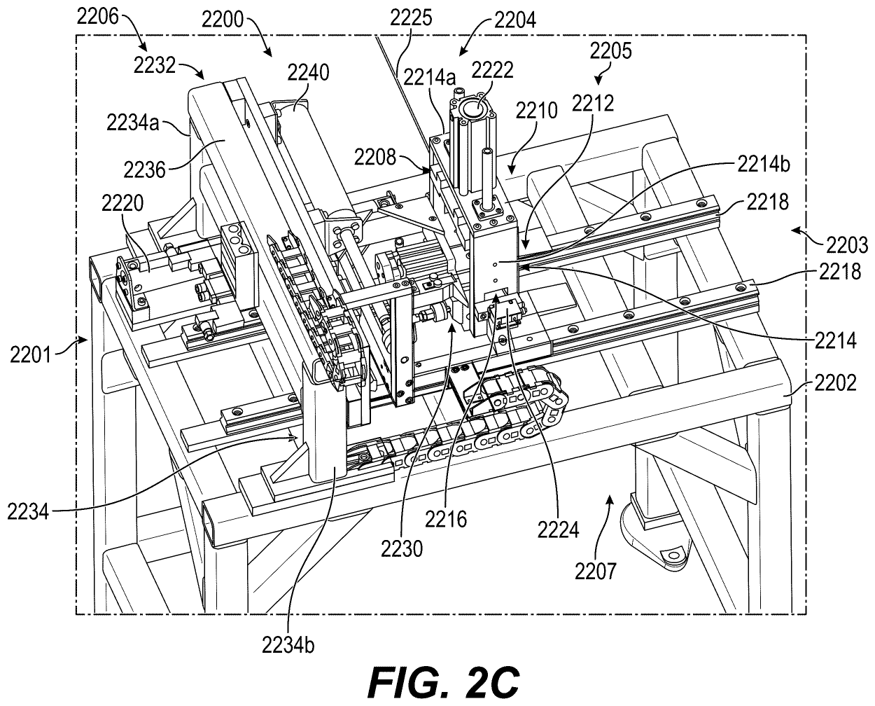

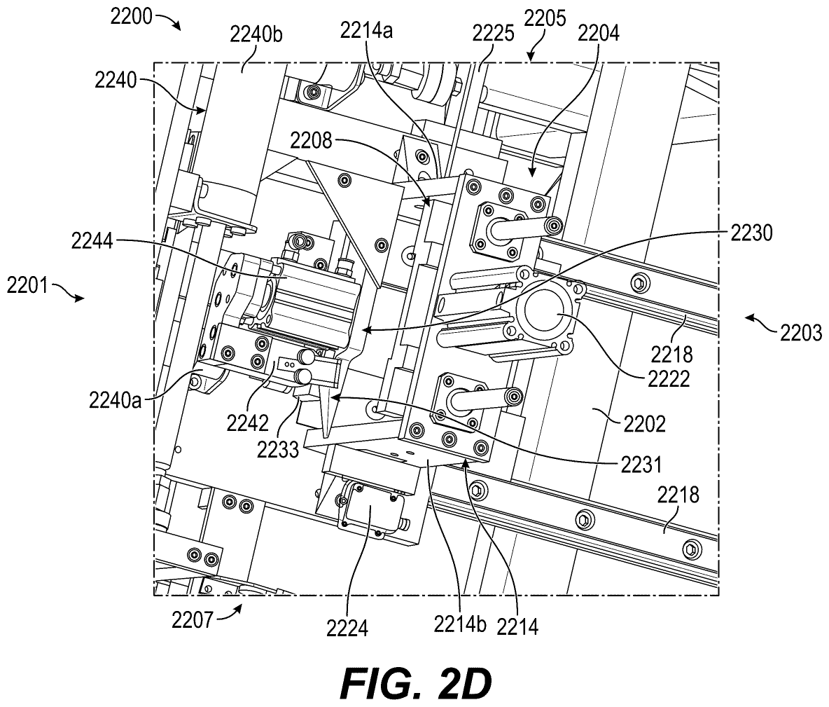

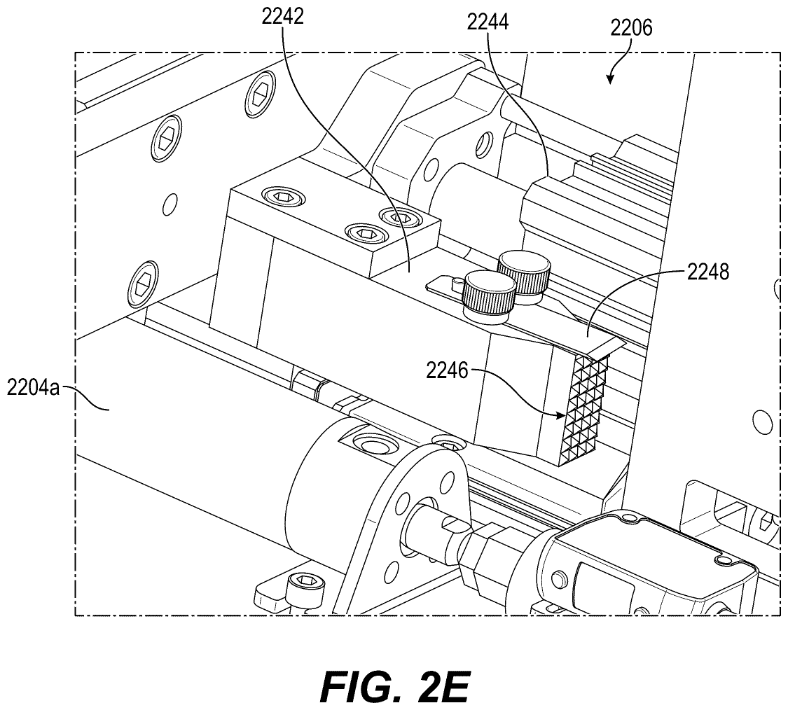

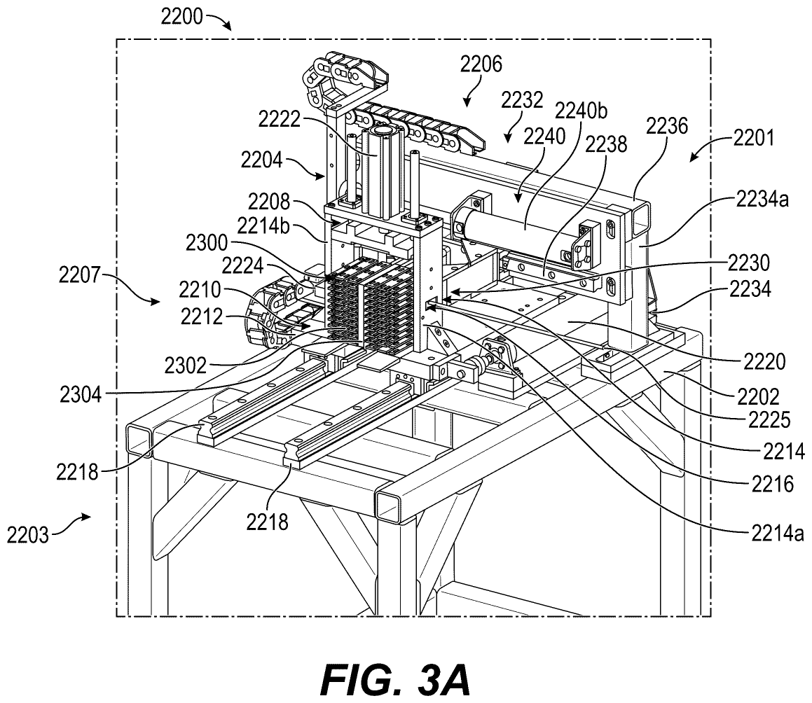

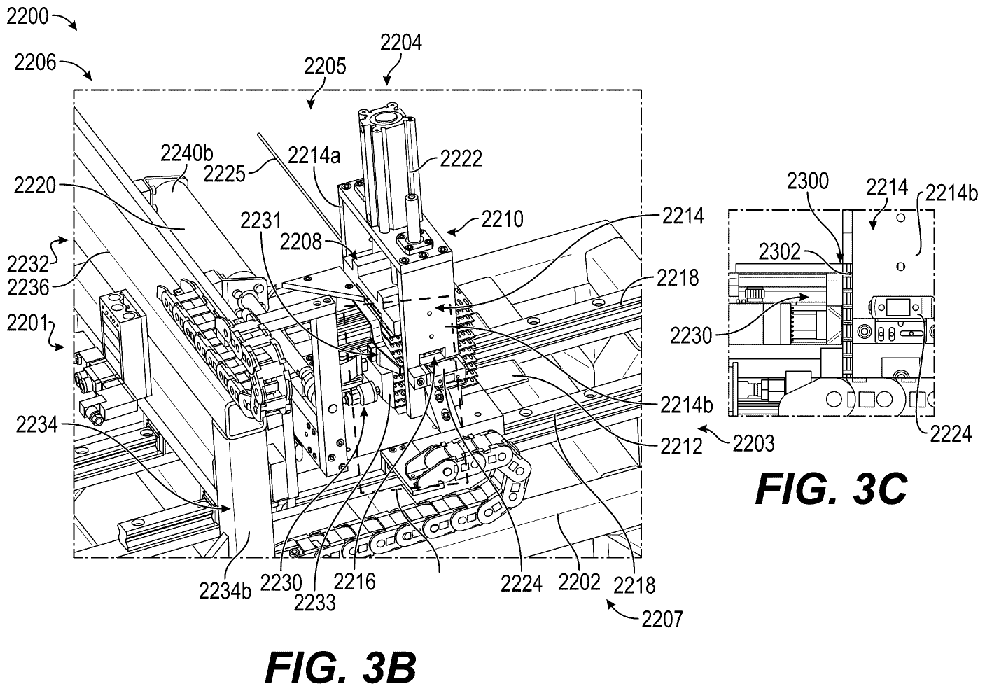

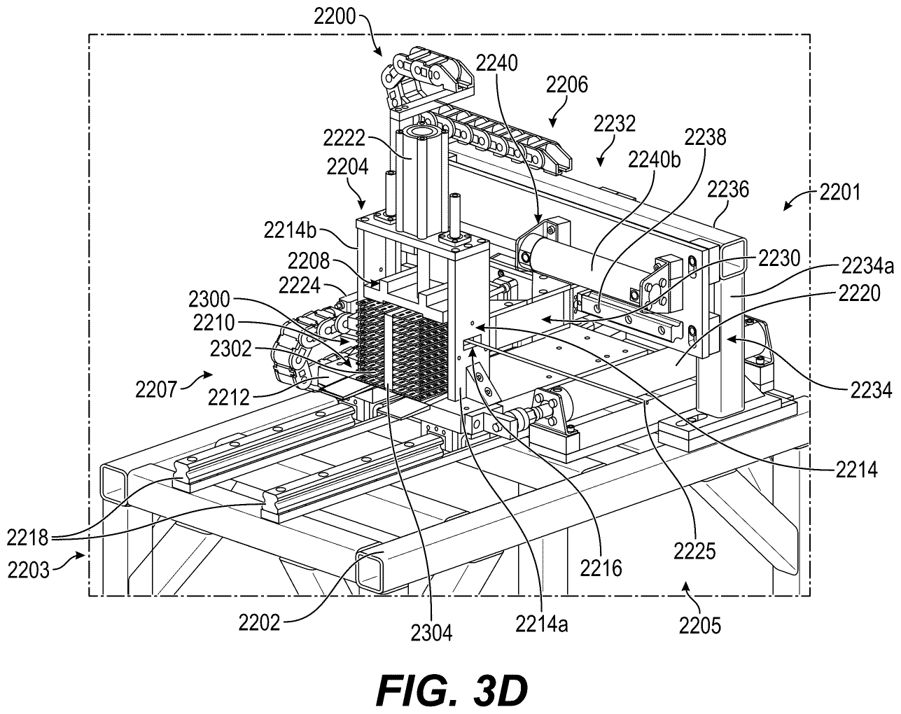

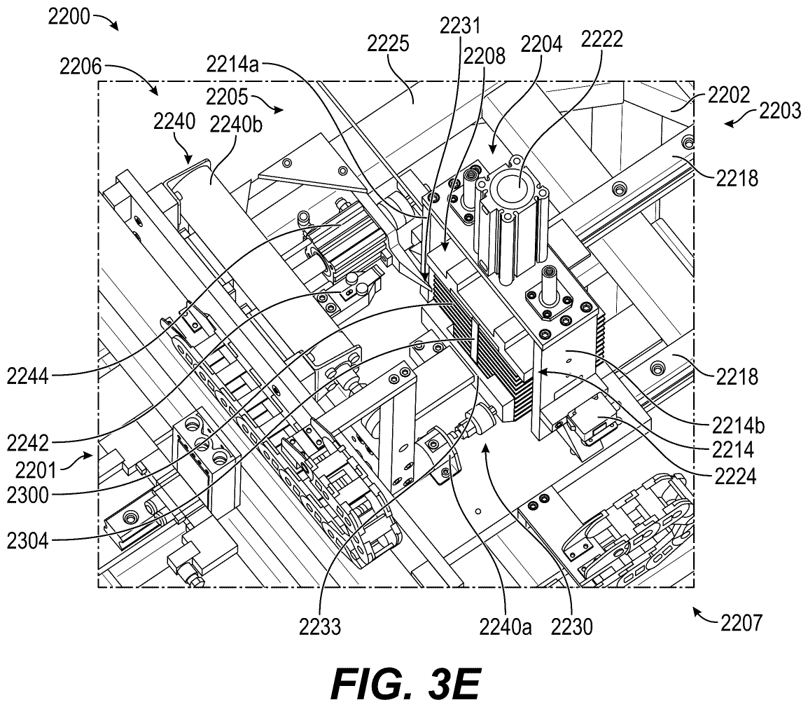

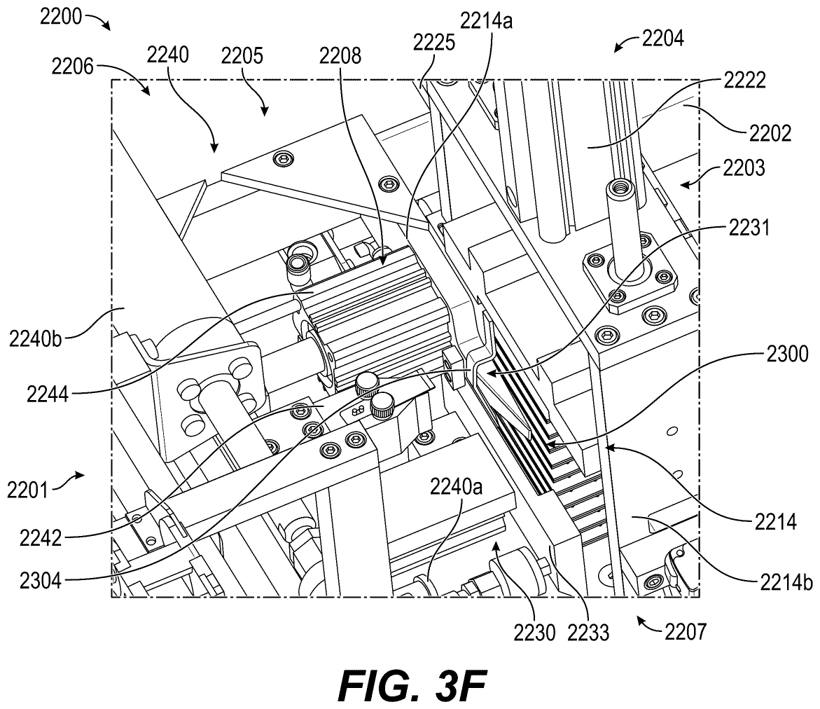

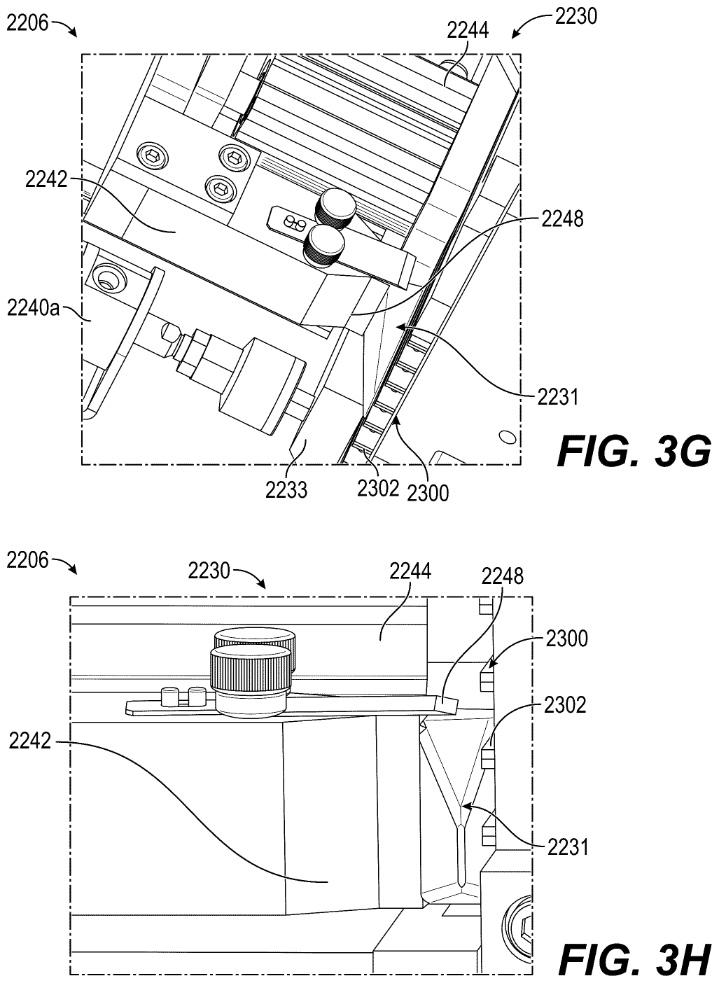

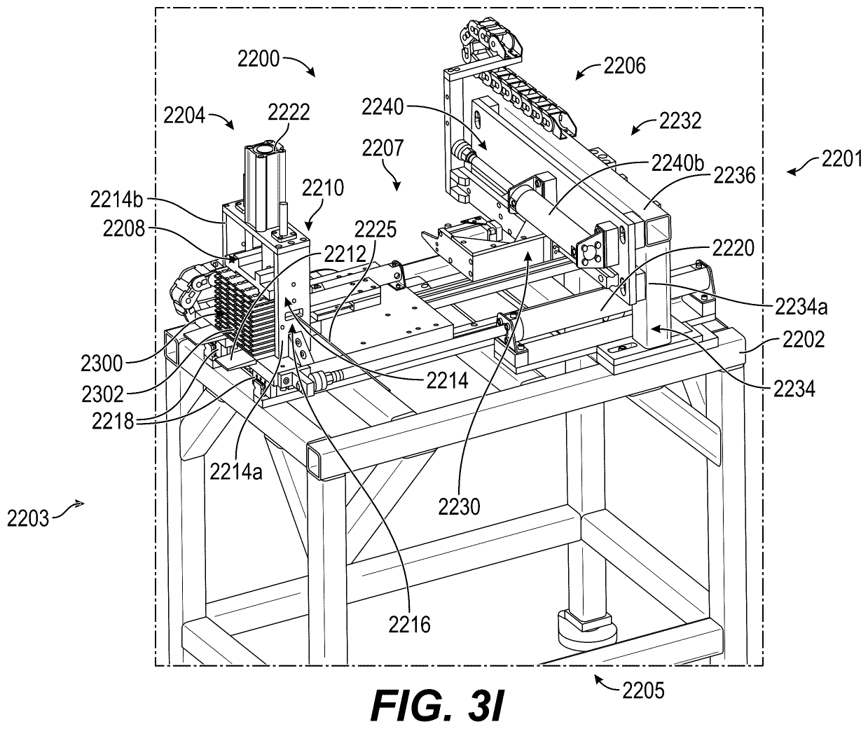

As shown in FIG. 1, the system 1 also includes one or more nail plate stack de-bander systems 2200 for de-banding nail plate stacks 2300 (FIG. 3A). The system 1 includes a bottom nail plate stack de-bander system 2200a and a top nail plate stack de-bander system 2200b. The bottom nail plate stack de-bander system 2200a is a part of the BNP loading station 1300 and is positioned to deliver nail plate stacks 2300 to the BNP delivery station 1400. The top nail plate stack de-bander system 2200b is a part of the TNP loading station 1600 and is positioned to deliver nail plate stacks 2300 to the TNP delivery station 1700. An exemplary nail plate stack de-bander 2200 is illustrated and detailed below with respect to the FIGS. 2A to 2E.

FIGS. 2A to 2E show various views of a nail plate stack de-bander system 2200, according to the present disclosure. The nail plate stack de-bander system 2200 extends from a proximal end 2201 to a distal end 2203 and includes a first side 2205 and a second side 2207 opposite the first side 2205. The first side 2205 and the second side 2207 extend from the proximal end 2201 to the distal end 2203. The nail plate stack de-bander system 2200 includes a nail plate stack de-bander frame 2202, a stack press assembly 2204, and a stack de-bander assembly 2206. The stack press assembly 2204 and the stack de-bander assembly 2206 are coupled to the nail plate stack de-bander frame 2202. In this way, the nail plate stack de-bander frame 2202 structurally supports the stack press assembly 2204 and the stack de-bander assembly 2206. For example, the nail plate stack de-bander frame 2202 includes one or more beams, walls, or the like, for providing a support frame for the components of the stack press assembly 2204 and the stack de-bander assembly 2206.

The stack de-bander assembly 2206 is coupled to the nail plate stack de-bander frame 2202 at the proximal end 2201. The stack press assembly 2204 is movably coupled to the nail plate stack de-bander frame 2202 adjacent the stack de-bander assembly 2206. The stack press assembly 2204 is configured to receive and hold a nail plate stack 2300 (FIG. 3A), as detailed further below. The stack de-bander assembly 2206 is configured to cut a band 2304 (FIG. 3A) of the nail plate stack 2300 from the nail plate stack 2300 to de-band the nail plate stack 2300 while the stack press assembly 2204 is holding the nail plate stack 2300, as detailed further below. After the stack de-bander assembly 2206 de-bands the nail plate stack 2300, the stack press assembly 2204 is further configured to move the nail plate stack 2300 from the proximal end 2201 towards the distal end 2203. In this way, the nail plate stack 2300 can be removed from the nail plate stack de-bander system 2200, for example, by the BNP delivery station 1400 or the TNP delivery station 1700.

The stack press assembly 2204 includes a stack press 2208 and a stack press carriage, also referred to as a stack press frame 2210. The stack press 2208 is a plate, or the like, that is movably mounted in the stack press frame 2210. The stack press assembly 2204 is configured to move the stack press 2208 vertically to generate a compressive force on the nail plate stack 2300. The stack press frame 2210 includes a stack press frame base 2212 and one or more stack press frame arms 2214. For example, the stack press frame arms 2214 include a first stack press frame arm 2214a and a second stack press frame arm 2214b laterally spaced from the first stack press frame arm 2214a. The stack press frame arms 2214 can include any number of stack press frame arms 2214, as desired, for supporting the stack press 2208. The stack press frame arms 2214 extend vertically from the stack press frame base 2212, and the stack press 2208 is movably mounted between the stack press frame arms 2214 (e.g., between the first stack press frame arm 2214a and the second stack press frame arm 2214b). The stack press frame arms 2214 include one or more stack press frame arm apertures 2216 disposed through the stack press frame arms 2214. The stack press frame arm apertures 2216 allow a nail plate stack sensor to sense the nail plate stack 2300 within the stack press frame 2210, as detailed further below.

The stack press assembly 2204 includes one or more stack press assembly rails 2218. The stack press frame 2210 is movably mounted to the one or more stack press assembly rails 2218. In this way, the stack press frame 2210 can move along the one or more stack press assembly rails 2218. The stack press assembly rails 2218 are coupled to the nail plate stack de-bander frame 2202. The stack press assembly rails 2218 extend from the proximal end 2201 to the distal end 2203. In this way, the stack press frame 2210 moves along the stack press assembly rails 2218 from the proximal end 2201 to the distal end 2203. The stack press assembly 2204 can also move along the stack press assembly rails 2218 from the distal end 2203 to the proximal end 2201.

The stack press assembly 2204 includes one or more stack press frame actuators 2220 and one or more stack press actuators 2222. The one or more stack press frame actuators 2220 are coupled to the stack press frame 2210 and are configured to actuate the stack press frame 2210 to move the stack press frame 2210, for example, along the stack press assembly rails 2218 between the proximal end 2201 and the distal end 2203. The one or more stack press frame actuators 2220 are hydraulic cylinders, or the like, for moving the stack press frame 2210. The one or more stack press frame actuators 2220 can include any type of linear actuator for moving the stack press frame 2210.

The one or more stack press actuators 2222 are coupled to the stack press 2208 and are configured to actuate the stack press 2208 to move the stack press 2208, for example, vertically within the stack press frame 2210 (e.g., up and down within the stack press frame 2210). The one or more stack press actuators 2222 are hydraulic cylinders, or the like, for moving the stack press 2208. The one or more stack press actuators 2222 can include any type of linear actuator for moving the stack press 2208 vertically to compress against the nail plate stack 2300, as detailed further below.

The stack press assembly 2204 also includes a nail plate stack sensor 2224 for sensing the nail plate stack 2300 in the stack press frame 2210. The nail plate stack sensor 2224 is mounted to the stack press frame 2210 to sense the nail plate stack sensor 2224. For example, the nail plate stack sensor 2224 is a proximity sensor that is oriented to emit a beam 2225 (e.g., a beam of electromagnetic radiation or an electromagnetic field). For example, the nail plate stack sensor 2224 emits the beam 2225 through the one or more stack press frame arm apertures 2216. The nail plate stack sensor 2224 senses a change in the beam 2225 (or a return signal) to detect that the nail plate stack 2300 has been placed in the stack press frame 2210, as detailed further below.

The stack de-bander assembly 2206 includes a stack band spear assembly 2230 and a stack de-bander frame 2232. The stack band spear assembly 2230 engages the band 2304 and cuts the band 2304 from the nail plate stack 2300, as detailed further below. The stack band spear assembly 2230 is movably coupled to the stack de-bander frame 2232. The stack de-bander frame 2232 includes one or more stack de-bander frame arms 2234 and a stack de-bander frame base 2236. For example, the stack de-bander frame arms 2234 include a first stack de-bander frame arm 2234a and a second stack de-bander frame arm 2234b laterally spaced from the first stack de-bander frame arm 2234a. The stack de-bander frame base 2236 extends between the stack de-bander frame arms 2234 (e.g., extends from the first stack de-bander frame arm 2234a to the second stack de-bander frame arm 2234b). The stack de-bander frame arms 2234 are coupled to the nail plate stack de-bander frame 2202 such that the nail plate stack de-bander frame 2202 supports the stack de-bander frame 2232, and, thus, supports the stack band spear assembly 2230.

The stack de-bander assembly 2206 includes one or more stack band spear assembly rails 2238. The stack band spear assembly 2230 is movably mounted to the one or more stack band spear assembly rails 2238. In this way, the stack band spear assembly 2230 can move along the one or more stack band spear assembly rails 2238. The stack band spear assembly rails 2238 are coupled to the stack de-bander frame 2232. In particular, the stack band spear assembly rails 2238 are couples to the stack de-bander frame base 2236. The stack band spear assembly rails 2238 extend from the first side 2205 to the second side 2207. In this way, the stack band spear assembly 2230 moves along the stack band spear assembly rails 2238 from the first side 2205 to the second side 2207. The stack band spear assembly 2230 can also move along the stack band spear assembly rails 2238 from the second side 2207 to the first side 2205.

The stack de-bander assembly 2206 includes one or more stack band spear actuators 2240 for moving the stack band spear assembly 2230. The stack band spear actuators 2240 are hydraulic cylinders, or the like, for moving the stack band spear assembly 2230. The stack band spear actuators 2240 can include any type of actuator for moving the stack band spear assembly 2230 between the proximal end 2201 towards the distal end 2203 and between the first side 2205 and the second side 2207.

The one or more stack band spear actuators 2240 include a first stack band spear actuator 2240a and a second stack band spear actuator 2240b. The first stack band spear actuator 2240a is coupled to the stack band spear assembly 2230 and is configured to actuate the stack band spear assembly 2230 to move the stack band spear assembly 2230 from the proximal end 2201 towards the distal end 2203 to engage the nail plate stack 2300, as detailed further below. The second stack band spear actuator 2240b is coupled to the stack band spear assembly and is configured to actuate the stack band spear assembly 2230 to move the stack band spear assembly 2230, for example, along the stack band spear assembly rails 2238 between the first side 2205 and the second side 2207, as detailed further below.

With reference to FIG. 2D, the stack band spear assembly 2230 includes a stack band spear 2231, a stack band spear plate 2233, a stack band cutter 2242, and a stack band cutter actuator 2244. The stack band spear 2231 is configured to engage the band 2304 to lift the band 2304 from nail plate stack 2300, as detailed further below. In particular, the stack band spear 2231 is a wedge, or the like, and includes a pointed tip and a tapered surface such that the stack band spear 2231 slides underneath the band 2304 to lift the band 2304 from the nail plate stack 2300. The stack band spear 2231 extends between the first side 2205 and the second side 2207 such that the stack band spear 2231 extends parallel to the nail plate stack 2300. The stack band spear plate 2233 engages the nail plate stack 2300 to help locate the nail plate stack 2300 within the stack press frame 2210. The stack band spear plate 2233 includes a flat surface for contacting the nail plate stack 2300. The stack band cutter 2242 is configured to cut the band 2304 from the nail plate stack 2300, as detailed further below. In particular, the stack band cutter 2242 is arranged perpendicular to the nail plate stack 2300 to move towards the nail plate stack 2300 and to cut the band 2304 from the nail plate stack 2300. The stack band cutter actuator 2244 is configured to move the stack band cutter 2242 from the proximal end 2201 towards the nail plate stack 2300 to cut the band 2304. The stack band cutter actuator 2244 then moves the stack band cutter 2242 from the nail plate stack 2300 towards the proximal end 2201. The stack band cutter actuator 2244 is a hydraulic cylinder, or the like, for moving the stack band cutter 2242. The stack band cutter actuator 2244 can include any type of actuator for moving the stack band cutter 2242.

With reference to FIG. 2E, the stack band cutter 2242 includes a plurality of stack band cutter teeth 2246 and a stack band cutter knife 2248. The plurality of stack band cutter teeth 2246 extend distally from the stack band cutter 2242 and are configured to engage the stack band spear 2231 to press the stack band spear 2231 and trap the band 2304, as detailed further below. The stack band cutter knife 2248 includes a sharp edge for cutting the band 2304 from the nail plate stack 2300. The stack band cutter knife 2248 is coupled to the stack band cutter 2242 and extends distally beyond the distal end 2203 of the stack band cutter 2242.

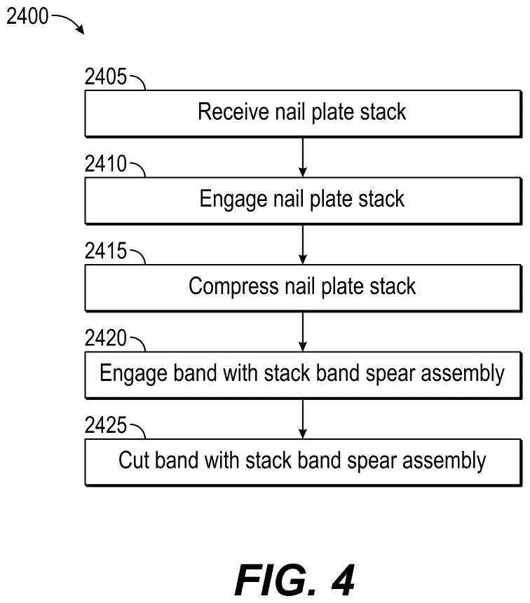

FIGS. 3A to 3I show various views of the nail plate stack de-bander system 2200 and illustrate a various steps of a method 2400 of de-banding a nail plate stack 2300 with the nail plate stack de-bander system 2200, according to the present disclosure. The nail plate stack 2300 includes a plurality of nail plates 2302 in a stack and coupled together by a band 2304. The nail plates 2302 are flat strips of metal (e.g., sheet metal or the like) that each include a plurality of nails extending therefrom. The method 2400 is detailed below with reference to FIG. 4.

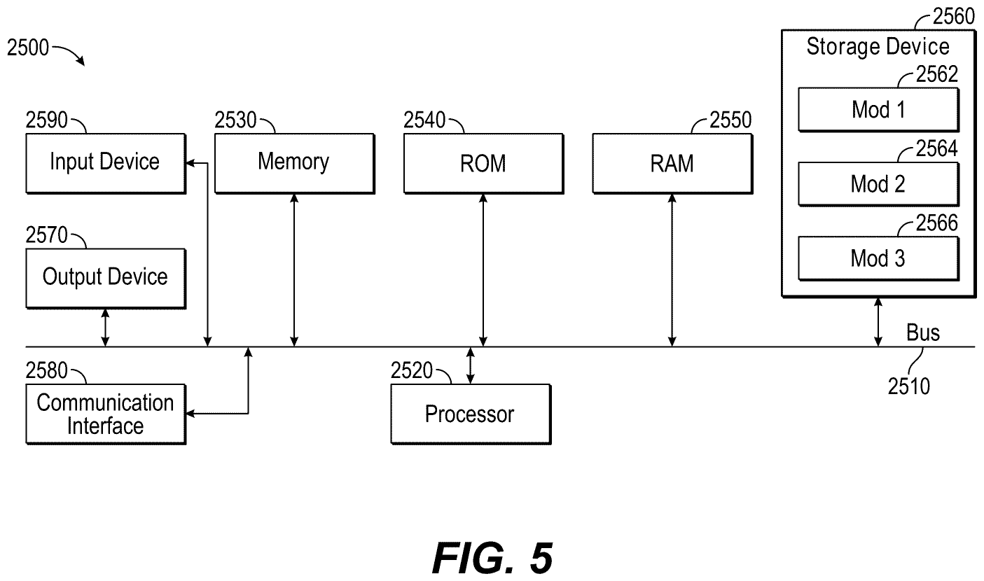

FIG. 4 is a flow diagram of the method 2400 of de-banding a nail plate stack 2300, according to the present disclosure. The method 2400 can proceed automatically, for example, by a processor (e.g., of the computing device 2500 of FIG. 5) controlling the nail plate stack de-bander system 2200. In the description of the method 2400, reference will be made to FIGS. 3A to 3I.

In step 2405, the method 2400 includes receiving, at the nail plate stack de-bander system 2200, the nail plate stack 2300. As shown in FIG. 3A, the nail plate stack de-bander system 2200 receives the nail plate stack 2300 within the stack press frame 2210. For example, a human (e.g., by hand or by machine) or a robot can place the nail plate stack 2300 within the stack press frame 2210 between the stack press frame arms 2214.

In step 2410, the method 2400 includes engaging the nail plate stack 2300. As shown in FIGS. 3B and 3C, the nail plate stack de-bander system 2200 moves the stack band spear assembly 2230 to engage the nail plate stack 2300. In particular, the nail plate stack de-bander system 2200 controls the first stack band spear actuator 2240a to actuate the stack band spear assembly 2230 to move the stack band spear assembly 2230 from the proximal end 2201 towards the nail plate stack 2300 to engage the nail plate stack 2300. The stack band spear plate 2233 presses against the nail plate stack 2300 to engage the nail plate stack 2300.

In some embodiments, the stack band spear assembly 2230 is positioned at an engaging position prior to the nail plate stack de-bander system 2200 receiving the nail plate stack 2300. In such embodiments, the engaging the nail plate stack 2300 includes the nail plate stack 2300 contacting the stack band spear plate 2233 as the nail plate stack de-bander system 2200 receives the nail plate stack 2300.

In step 2415, the method 2400 includes compressing the nail plate stack 2300. As shown in FIG. 3D, the compressing the nail plate stack 2300 includes lowering the stack press 2208 to engage the nail plate stack 2300. In particular, the nail plate stack de-bander system 2200 controls the one or more stack press actuators 2222 to actuator and lower the stack press 2208 towards the nail plate stack 2300. Compressing the nail plate stack 2300 causes the band 2304 to expand outward from the nail plate stack 2300.

In step 2420, the method 2400 includes engaging the band 2304 with the stack band spear assembly 2230. As shown in FIG. 3E, the nail plate stack de-bander system 2200 moves the stack band spear assembly 2230 towards the first side 2205. For example, the nail plate stack de-bander system 2200 controls the one or more second stack band spear actuators 2240b to actuate and to move the stack band spear assembly 2230 towards the first side 2205. In particular, the nail plate stack de-bander system 2200 moves the stack band spear 2231 and the stack band cutter 2242 toward the first side 2205, and the stack band spear plate 2233 remains stationary at the nail plate stack 2300. In this way, the stack band spear plate 2233 holds or secures the nail plate stack 2300 while the stack band spear 2231 and the stack band cutter 2242 move towards the first side 2205.

As shown in FIG. 3F, the nail plate stack de-bander system 2200 then moves the stack band spear assembly 2230 towards the second side 2207 to engage the band 2304. For example, the nail plate stack de-bander system 2200 controls the one or more second stack band spear actuators 2240b to actuate and to move the stack band spear assembly 2230 towards the second side 2207. In particular, the nail plate stack de-bander system 2200 moves the stack band spear 2231 and the stack band cutter 2242 towards the second side 2207. As the stack band spear 2231 moves towards the second side 2207, the stack band spear 2231 slides between the band 2304 and the nail plate stack 2300, and, thus, pulls the band 2304 away from the nail plate stack 2300. In particular, the band 2304 expands due to the tapered surface of the stack band spear 2231 as the stack band spear 2231 slides between the band 2304 and the nail plate stack 2300. In this way, the stack band spear assembly 2230 engages the band 2304. The stack band spear assembly 2230 moves until the stack band cutter 2242 is aligned with the band 2304.

In step 2425, the method 2400 includes cutting the band 2304 with the stack band spear assembly 2230 to de-band the nail plate stack 2300. As shown in FIGS. 3G and 3H, the nail plate stack de-bander system 2200 moves the stack band cutter 2242 towards the nail plate stack 2300 to cut the band 2304. In particular, the nail plate stack de-bander system 2200 controls the stack band cutter actuator 2244 to actuator and to move the stack band cutter 2242 towards the distal end 2203, and, thus, towards the band 2304 on the nail plate stack 2300. The stack band cutter teeth 2246 engage the stack band spear 2231 to trap the band 2304 and allow the stack band cutter knife 2248 to pass over the stack band spear 2231 and to cut the band 2304. In this way, the nail plate stack 2300 is de-banded. The stack band spear 2231 then retracts, and the stack band cutter 2242 opens, thus causing the band 2304 to fall out of the nail plate stack de-bander system 2200 (e.g., into a receptacle, or the like).

With reference to FIG. 3I, after the nail plate stack 2300 has been de-banded, the nail plate stack de-bander system 2200 moves the nail plate stack 2300 towards the distal end 2203 such that the nail plates 2302 can be easily removed from the nail plate stack de-bander system 2200. In particular, the nail plate stack de-bander system 2200 controls the one or more stack press frame actuators 2220 to actuate and to move the stack press frame 2210 (with the nail plate stack 2300 therein) to the distal end 2203. The nail plate stack de-bander system 2200 can then move the stack press frame 2210 back towards the proximal end 2201 to receive a new nail plate stack 2300 for de-banding the new nail plate stack 2300. In this way, the method 2400 restarts as step 2405 to de-band the new nail plate stack 2300.

FIG. 5 illustrates a computing device 2500 for controlling aspects of the nail plate stack de-bander system 2200, according to the present disclosure. The computing device 2500 can carry out instructions for controlling the components of the nail plate stack de-bander system 2200, such as, for example, the stack press assembly 2204 and the stack de-bander assembly 2206. While a single computing device 2500 is illustrated in FIG. 5, the nail plate stack de-bander system 2200 can include any number of computing devices 2500 for controlling the components thereof, and performing the method 2400 of de-banding a nail plate stack 2300.

The computing device 2500 includes a processing unit (CPU or processor) 2520 and a system bus 2510 that couples various system components including a memory 2530 such as read-only memory (ROM) 2540 and random-access memory (RAM) 2550 to the processor 2520. The computing device 2500 can include a cache of high-speed memory connected directly with, in close proximity to, or integrated as part of the processor 2520. The computing device 2500 copies data from the memory 2530 and/or the storage device 2560 to the cache for quick access by the processor 2520. In this way, the cache provides a performance boost that avoids processor 2520 delays while waiting for data. These and other modules can control or be configured to control the processor 2520 to perform various actions. Other memory 2530 may be available for use as well. The memory 2530 can include multiple different types of memory with different performance characteristics. It can be appreciated that the disclosure may operate on a computing device 2500 with more than one processor 2520 or on a group or cluster of computing devices networked together to provide greater processing capability. The processor 2520 can include any general-purpose processor and a hardware module or software module, such as module 1 2562, module 2 2564, and module 3 2566 stored in storage device 2560, configured to control the processor 2520 as well as a special-purpose processor where software instructions are incorporated into the actual processor design. The processor 2520 may essentially be a completely self-contained computing system, containing multiple cores or processors, a bus, memory controller, cache, etc. A multi-core processor may be symmetric or asymmetric.

The system bus 2510 may be any of several types of bus structures including a memory bus or memory controller, a peripheral bus, and a local bus using any of a variety of bus architectures. A basic input/output (BIOS) stored in ROM 2540 or the like, may provide the basic routine that helps to transfer information between elements within the computing device 2500, such as during start-up. The computing device 2500 further includes storage devices 2560 such as a hard disk drive, a magnetic disk drive, an optical disk drive, tape drive or the like. The storage device 2560 can include software modules 2562, 2564, 2566 for controlling the processor 2520. Other hardware or software modules are contemplated. The storage device 2560 is connected to the system bus 2510 by a drive interface. The drives and the associated computer-readable storage media provide nonvolatile storage of computer-readable instructions, data structures, program modules and other data for the computing device 2500. In one aspect, a hardware module that performs a particular function includes the software component stored in a tangible computer-readable storage medium in connection with the necessary hardware components, such as the processor 2520, system bus 2510, output device 2570, and so forth, to carry out the function. In another aspect, the system can use a processor and computer-readable storage medium to store instructions which, when executed by a processor (e.g., one or more processors), cause the processor to perform a method or other specific actions. The basic components and appropriate variations are contemplated depending on the type of device, such as whether the computing device 2500 is a small, handheld computing device, a desktop computer, or a computer server.

Although the exemplary embodiment described herein employs the storage device 2560, other types of computer-readable media which can store data that are accessible by a computer, such as magnetic cassettes, flash memory cards, digital versatile disks, cartridges, random-access memories (RAMs) 2550, and read-only memory (ROM) 2540, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 2500, an input device 2590 represents any number of input mechanisms, such as a microphone for speech, a touch-sensitive screen for gesture or graphical input, keyboard, mouse, motion input, speech and so forth. An output device 2570 can also be one or more of a number of output mechanisms known to those of skill in the art, such as, for example, a display. In some instances, multimodal systems enable a user to provide multiple types of input to communicate with the computing device 2500. The communications interface 2580 generally governs and manages the user input and system output. There is no restriction on operating on any particular hardware arrangement and therefore the basic features here may easily be substituted for improved hardware or firmware arrangements as they are developed.

Further aspects of the present disclosure are provided by the subject matter of the following clauses.

A nail plate stack de-bander system for de-banding a nail plate stack including a plurality of nail plates coupled together by a band, the nail plate stack de-bander system comprising a stack press assembly including a stack press, the stack press assembly being configured to receive the nail plate stack, and the stack press being configured to compress the nail plate stack such that the band expands outwards from the nail plate stack, and a stack de-bander assembly including a stack band spear assembly, the stack de-bander assembly configured to move the stack band spear assembly to cut the band from the nail plate stack to de-band the nail plate stack.

The nail plate stack de-bander system of the preceding clause, further comprising a first side and a second side opposite the first side, the first side and the second side extending between a proximal end and a distal end, the stack de-bander assembly being positioned at the proximal end.

The nail plate stack de-bander system of any preceding clause, wherein the stack press assembly is positioned between the stack de-bander assembly and the distal end, and the stack press assembly is configured to move the nail plate stack to towards the distal end after the nail plate stack has been de-banded.

The nail plate stack de-bander system of any preceding clause, further comprising a nail plate stack de-bander frame, the stack press assembly and the stack de-bander assembly being coupled to the nail plate stack de-bander frame.

The nail plate stack de-bander system of any preceding clause, wherein the stack press assembly includes a stack press frame, the stack press being moveably mounted within the stack press frame, the stack press being configured to move vertically within the stack press frame.

The nail plate stack de-bander system of any preceding clause, wherein the stack press assembly includes one or more stack press assembly rails, the stack press frame being movably mounted to the one or more stack press assembly rails.

The nail plate stack de-bander system of any preceding clause, wherein the stack press assembly includes one or more stack press frame actuators that are configured to move the stack press frame.

The nail plate stack de-bander system of any preceding clause, wherein the stack press assembly includes one or more stack press actuators that are configured to move the stack press to compress the nail plate stack.

The nail plate stack de-bander system of any preceding clause, further comprising a nail plate stack sensor configured to sense the nail plate stack within the stack press assembly.

The nail plate stack de-bander system of any preceding clause, wherein the stack de-bander assembly includes a stack de-bander frame, the stack band spear assembly being movably mounted to the stack de-bander frame and being configured to move along the stack de-bander frame.

The nail plate stack de-bander system of any preceding clause, wherein the stack de-bander assembly includes one or more stack de-bander assembly rails, the stack band spear assembly being movably coupled to the one or more stack de-bander assembly rails.

The nail plate stack de-bander system of any preceding clause, wherein the stack de-bander assembly includes one or more stack band spear actuators configured to move the stack band spear assembly.

The nail plate stack de-bander system of any preceding clause, wherein the stack band spear assembly includes a stack band spear that is configured to engage the band to lift the band from the nail plate stack.

The nail plate stack de-bander system of any preceding clause, wherein the stack band spear assembly includes a stack band spear plate that is configured to engage the nail plate stack to locate the nail plate stack within the nail plate stack de-bander system.

The nail plate stack de-bander system of any preceding clause, wherein the stack band spear assembly includes a stack band cutter that is configured to cut the band from the nail plate stack to de-band the nail plate stack.

The nail plate stack de-bander system of any preceding clause, wherein the stack band cutter includes a stack band cutter knife that is configured to cut the band.

The nail plate stack de-bander system of any preceding clause, wherein the stack band spear assembly includes a stack band cutter actuator configured to move the stack band cutter towards the nail plate stack to cut the band.

The nail plate stack de-bander system of any preceding clause, wherein the stack band cutter includes a plurality of stack band cutter teeth that extend distally from the stack band cutter, the plurality of stack band cutter teeth engaging the band to trap the band.

A method of de-banding a nail plate stack including a plurality of nail plates coupled together by a band, the method comprising receiving, at the nail plate stack de-bander system of any preceding clause, the nail plate stack, compressing, with the stack press, the nail plate stack such that the band expands outward from the nail plate stack, and cutting, with the stack band spear assembly, the band from the nail plate stack to de-band the nail plate stack.

The method of the preceding clause, further comprising engaging, with the stack band spear assembly, the nail plate stack prior to compressing the nail plate stack.

The method of any preceding clause, further comprising engaging, with the stack band spear assembly, prior to cutting the band.

The method of any preceding clause, wherein the stack band spear assembly includes a stack band spear, the method further comprising moving the stack band spear towards band such that the stack band spear slides between band and the nail plate stack to pull the band away from nail plate stack.

The method of any preceding clause, wherein the stack band spear assembly includes a stack band cutter, the method further comprising engaging, with the stack band cutter, the stack band spear.

The method of any preceding clause, wherein the stack band cutter includes a plurality of stack band cutter teeth, and engaging the stack band spear includes engaging, with the stack band cutter teeth, the band to trap the band between stack band cutter and the stack band spear.

The method of any preceding clause, wherein the stack band spear assembly includes a stack band cutter having a stack band cutter knife, the method further comprising cutting, with the stack band cutter knife, the band from the nail plate stack.

The method of any preceding clause, wherein the nail plate stack de-bander system includes a first side and a second side opposite the first side, the first side and the second side extending between a proximal end and a distal end, and the method further comprising moving, with the stack press assembly, the nail plate stack towards the distal end after the nail plate stack has been de-banded.

The method of any preceding clause, further comprising sensing, with a nail plate stack sensor, the nail plate stack within the stack press assembly.

Although the foregoing description is directed to the preferred embodiments, it is noted that other variations and modifications will be apparent to those skilled in the art and may be made without departing from the spirit or scope of the disclosure. Moreover, features described in connection with one embodiment may be used in conjunction with other embodiments, even if not explicitly stated above.

1. A nail plate stack de-bander system for de-banding a nail plate stack including a plurality of nail plates coupled together by a band, the nail plate stack de-bander system comprising:
a stack press assembly including a stack press, the stack press assembly being configured to receive the nail plate stack, and the stack press being configured to compress the nail plate stack such that the band expands outwards from the nail plate stack; and
a stack de-bander assembly including a stack band spear assembly, the stack de-bander assembly configured to move the stack band spear assembly to cut the band from the nail plate stack to de-band the nail plate stack.

2. The nail plate stack de-bander system of claim 1, further comprising a first side and a second side opposite the first side, the first side and the second side extending between a proximal end and a distal end, the stack de-bander assembly being positioned at the proximal end.

3. The nail plate stack de-bander system of claim 2, wherein the stack press assembly is positioned between the stack de-bander assembly and the distal end, and the stack press assembly is configured to move the nail plate stack to towards the distal end after the nail plate stack has been de-banded.

4. The nail plate stack de-bander system of claim 1, further comprising a nail plate stack de-bander frame, the stack press assembly and the stack de-bander assembly being coupled to the nail plate stack de-bander frame.

5. The nail plate stack de-bander system of claim 1, wherein the stack press assembly includes a stack press frame, the stack press being moveably mounted within the stack press frame, the stack press being configured to move vertically within the stack press frame.

6. The nail plate stack de-bander system of claim 5, wherein the stack press assembly includes one or more stack press assembly rails, the stack press frame being movably mounted to the one or more stack press assembly rails.

7. The nail plate stack de-bander system of claim 5, wherein the stack press assembly includes one or more stack press frame actuators that are configured to move the stack press frame.

8. The nail plate stack de-bander system of claim 1, wherein the stack press assembly includes one or more stack press actuators that are configured to move the stack press to compress the nail plate stack.

9. The nail plate stack de-bander system of claim 1, further comprising a nail plate stack sensor configured to sense the nail plate stack within the stack press assembly.

10. The nail plate stack de-bander system of claim 1, wherein the stack de-bander assembly includes a stack de-bander frame, the stack band spear assembly being movably mounted to the stack de-bander frame and being configured to move along the stack de-bander frame.

11. The nail plate stack de-bander system of claim 10, wherein the stack de-bander assembly includes one or more stack de-bander assembly rails, the stack band spear assembly being movably coupled to the one or more stack de-bander assembly rails.

12. The nail plate stack de-bander system of claim 10, wherein the stack de-bander assembly includes one or more stack band spear actuators configured to move the stack band spear assembly.

13. The nail plate stack de-bander system of claim 1, wherein the stack band spear assembly includes a stack band spear that is configured to engage the band to lift the band from the nail plate stack.

14. The nail plate stack de-bander system of claim 1, wherein the stack band spear assembly includes a stack band spear plate that is configured to engage the nail plate stack to locate the nail plate stack within the nail plate stack de-bander system.

15. The nail plate stack de-bander system of claim 1, wherein the stack band spear assembly includes a stack band cutter that is configured to cut the band from the nail plate stack to de-band the nail plate stack.

16. The nail plate stack de-bander system of claim 15, wherein the stack band cutter includes a stack band cutter knife that is configured to cut the band.

17. The nail plate stack de-bander system of claim 15, wherein the stack band spear assembly includes a stack band cutter actuator configured to move the stack band cutter towards the nail plate stack to cut the band.

18. The nail plate stack de-bander system of claim 15, wherein the stack band cutter includes a plurality of stack band cutter teeth that extend distally from the stack band cutter, the plurality of stack band cutter teeth engaging the band to trap the band.

19. A method of de-banding a nail plate stack including a plurality of nail plates coupled together by a band, the method comprising:
receiving, at the nail plate stack de-bander system of claim 1, the nail plate stack;
compressing, with the stack press, the nail plate stack such that the band expands outward from the nail plate stack; and
cutting, with the stack band spear assembly, the band from the nail plate stack to de-band the nail plate stack.

20. The method of claim 19, further comprising engaging, with the stack band spear assembly, the nail plate stack prior to compressing the nail plate stack.

21. The method of claim 19, further comprising engaging, with the stack band spear assembly, prior to cutting the band.

22. The method of claim 21, wherein the stack band spear assembly includes a stack band spear, the method further comprising moving the stack band spear towards band such that the stack band spear slides between band and the nail plate stack to pull the band away from nail plate stack.

23. The method of claim 22, wherein the stack band spear assembly includes a stack band cutter, the method further comprising engaging, with the stack band cutter, the stack band spear.

24. The method of claim 23, wherein the stack band cutter includes a plurality of stack band cutter teeth, and engaging the stack band spear includes engaging, with the stack band cutter teeth, the band to trap the band between stack band cutter and the stack band spear.

25. The method of claim 19, wherein the stack band spear assembly includes a stack band cutter having a stack band cutter knife, the method further comprising cutting, with the stack band cutter knife, the band from the nail plate stack.

26. The method of claim 19, wherein the nail plate stack de-bander system includes a first side and a second side opposite the first side, the first side and the second side extending between a proximal end and a distal end, and the method further comprising moving, with the stack press assembly, the nail plate stack towards the distal end after the nail plate stack has been de-banded.

27. The method of claim 19, further comprising sensing, with a nail plate stack sensor, the nail plate stack within the stack press assembly.
